(19) United States
(12) Patent Application Publication
(10) Pub. No.: US 2024/0319385 A1
(43) Pub. Date: Sep. 26, 2024

(54) PRECISE POSITIONING USING DIFFERENTIAL CARRIER PHASE (DCP)-BASED MEASUREMENT UPDATES

(71) Applicant: QUALCOMM Incorporated, San Diego, CA (US)

(72) Inventors: Min WANG, Tustin, CA (US); James STEPHEN, Lake Forest, CA (US); Ning LUO, Cupertino, CA (US); Yinghua YANG, San Jose, CA (US); Yuxiang PENG, Sunnyvale, CA (US); Furqan AHMED, Eastvale, CA (US)

(21) Appl. No.: 18/189,941

(22) Filed: Mar. 24, 2023

(51) Int. Cl. G01S 19/43; G01S 19/39; G01S 19/41; G01S 19/42

(52) U.S. Cl. CPC G01S 19/43; G01S 19/393; G01S 19/396; G01S 19/41; G01S 19/425

(57) ABSTRACT

Techniques for precise positioning using differential carrier phase (DCP)-based measurement updates are disclosed. The techniques can include obtaining a pseudorange observation for a positioning epoch and a carrier phase observation for the positioning epoch based on measurements of global navigation satellite system (GNSS) signals transmitted by one or more space vehicles (SVs) of a GNSS constellation, generating a differential carrier phase observation for the positioning epoch based on the carrier phase observation for the positioning epoch and a determination that real-time kinematic (RTK) correction data associated with the GNSS constellation is unavailable, and generating a position, velocity, and time (PVT) observation of the mobile device for the positioning epoch based on the differential carrier phase observation for the positioning epoch.

### BACKGROUND

### 1. Field of Disclosure

The present disclosure relates generally to the field of wireless communications, and more specifically to mobile device positioning using radio frequency (RF) signals.

### 2. Description of Related Art

The global navigation satellite system (GNSS) is widely used for positioning of consumer electronic devices such as smartphones, as well as for positioning of vehicles such as cars, trucks, ships, and aircraft. High-accuracy positioning can provide significant value to various modern-day positioning-based applications. For example, an autonomous driving application may benefit from meter-level positioning information that enables it to determine which particular lane of a road an autonomously-driven vehicle is in, and may further benefit from sub-meter-level positioning information that enables it to determine where that vehicle is located within the lane.

According to a real-time kinematic (RTK)-based positioning scheme, a precise positioning engine (PPE) can utilize a RTK positioning service to generate high-accuracy positioning information based on GNSS measurements. This can involve correcting GNSS pseudorange and carrier phase observations using correction data provided by the RTK positioning service. The RTK correction data can include respective RTK correction data for multiple satellite constellations. If RTK correction data for a given GNSS constellation is not available from the RTK positioning service (for example, if a provider of the service has opted not to include RTK correction data for that constellation), or has become unavailable (for example, due to a service outage), then the PPE may be unable to obtain high-accuracy positioning information based on GNSS measurements associated with that GNSS constellation.

### BRIEF SUMMARY

An example positioning method for a mobile device, according to this disclosure, may include obtaining a pseudorange observation for a positioning epoch and a carrier phase observation for the positioning epoch based on measurements of global navigation satellite system (GNSS) signals transmitted by one or more space vehicles (SVs) of a GNSS constellation, generating a differential carrier phase observation for the positioning epoch based on the carrier phase observation for the positioning epoch and a determination that real-time kinematic (RTK) correction data associated with the GNSS constellation is unavailable, and generating a position, velocity, and time (PVT) observation of the mobile device for the positioning epoch based on the differential carrier phase observation for the positioning epoch.

An example positioning apparatus for a mobile device, according to this disclosure, may include a GNSS receiver, a memory, and one or more processors communicatively coupled with the GNSS receiver and the memory, where the one or more processors are configured to obtain a pseudorange observation for a positioning epoch and a carrier phase observation for the positioning epoch based on measurements of GNSS signals transmitted by one or more SVs of a GNSS constellation, generate a differential carrier phase observation for the positioning epoch based on the carrier phase observation for the positioning epoch and a determination that RTK correction data associated with the GNSS constellation is unavailable, and generate a PVT observation of the mobile device for the positioning epoch based on the differential carrier phase observation for the positioning epoch.

An example non-transitory computer-readable medium, according to this disclosure, may store instructions for positioning for a mobile device, and the instructions may include code for obtaining a pseudorange observation for a positioning epoch and a carrier phase observation for the positioning epoch based on measurements of GNSS signals transmitted by one or more SVs of a GNSS constellation, generating a differential carrier phase observation for the positioning epoch based on the carrier phase observation for the positioning epoch and a determination that RTK correction data associated with the GNSS constellation is unavailable, and generating a PVT observation of the mobile device for the positioning epoch based on the differential carrier phase observation for the positioning epoch.

An example positioning apparatus for a mobile device, according to this disclosure, may include means for obtaining a pseudorange observation for a positioning epoch and a carrier phase observation for the positioning epoch based on measurements of GNSS signals transmitted by one or more SVs of a GNSS constellation, means for generating a differential carrier phase observation for the positioning epoch based on the carrier phase observation for the positioning epoch and a determination that RTK correction data associated with the GNSS constellation is unavailable, and means for generating a PVT observation of the mobile device for the positioning epoch based on the differential carrier phase observation for the positioning epoch.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a simplified diagram of a GNSS system, according to an embodiment.

FIG. 3 is a simplified diagram of a real-time kinematic (RTK) system, according to an embodiment.

FIG. 4 is a block diagram illustrating a first example positioning scheme, according to aspects of the disclosure.

FIG. 5 is a block diagram illustrating a first example operating environment, according to aspects of the disclosure.

FIG. 6 is a block diagram illustrating a second example positioning scheme, according to aspects of the disclosure.

FIG. 7 is a block diagram illustrating a second example operating environment, according to aspects of the disclosure.

FIG. 8 is a block diagram illustrating an example positioning method, according to aspects of the disclosure.

FIG. 9 is a block diagram of an embodiment of a mobile device, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 110 may be indicated as 110-1, 110-2, 110-3 etc. or as 110a, 110b, 110c, etc. When referring to such an element using only the first number, any instance of the element is to be understood (e.g., element 110 in the previous example would refer to elements 110-1, 110-2, and 110-3 or to elements 110a, 110b, and 110c).

### DETAILED DESCRIPTION

Several illustrative examples will now be described with respect to the accompanying drawings, which form a part hereof. While particular examples, in which one or more aspects of the disclosure may be implemented, are described below, other examples may be used and various modifications may be made without departing from the scope of the disclosure or the spirit of the appended claims.

Reference throughout this specification to “one example” or “an example” means that a particular feature, structure, or characteristic described in connection with the example is included in at least one example of claimed subject matter. Thus, the appearances of the phrase “in one example” or “an example” in various places throughout this specification are not necessarily all referring to the same example. Furthermore, the particular features, structures, or characteristics may be combined in one or more examples.

The methodologies described herein may be implemented by various means depending upon applications according to particular examples. For example, such methodologies may be implemented in hardware, firmware, software, and/or combinations thereof. In a hardware implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices units designed to perform the functions described herein, and/or combinations thereof.

As used herein, the terms “mobile device” and “User Equipment” (UE) may be used interchangeably and are not intended to be specific or otherwise limited to any particular Radio Access Technology (RAT), unless otherwise noted. In general, a mobile device and/or UE may be any wireless communication device (e.g., a mobile phone, router, tablet computer, laptop computer, tracking device, wearable (e.g., smartwatch, glasses, Augmented Reality (AR)/Virtual Reality (VR) headset, etc.), vehicle (e.g., automobile, vessel, aircraft motorcycle, bicycle, etc.), Internet of Things (IoT) device, etc.), or other electronic device that may be used for Global Navigation Satellite Systems (GNSS) positioning as described herein. According to some embodiments, a mobile device and/or UE may be used to communicate over a wireless communications network. A UE may be mobile or may (e.g., at certain times) be stationary, and may communicate with a Radio Access Network (RAN). As used herein, the term UE may be referred to interchangeably as an Access Terminal (AT), a client device, a wireless device, a subscriber device, a subscriber terminal, a subscriber station, a user terminal (UT), a mobile device, a mobile terminal, a mobile station, or variations thereof. Generally, UEs can communicate with a core network via a RAN, and through the core network, the UEs can be connected with external networks (such as the Internet) and with other UEs. Other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 standard, etc.), and so on.

A “space vehicle” (SV) as referred to herein, relates to an object that is capable of transmitting signals to receivers on the earth's surface. In one particular example, such a SV may comprise a geostationary satellite. Alternatively, a SV may comprise a satellite traveling in an orbit and moving relative to a stationary position on the earth. However, these are merely examples of SVs and claimed subject matter is not limited in these respects. SVs also may be referred to herein simply as “satellites.”

As described herein, a GNSS receiver may comprise and/or be incorporated into an electronic device. This may include a single entity or may include multiple entities such as in a personal area network where a user may employ audio, video and/or data I/O devices and/or body sensors and a separate wireline or wireless modem. As described herein, an estimate of a location of the Global Positioning System (GPS) receiver may be referred to as a location, location estimate, location fix, fix, position, position estimate or position fix, and may be geodetic, thus providing location coordinates for the GPS receiver (e.g., latitude and longitude) which may or may not include an altitude component (e.g., height above sea level, height above or depth below ground level, floor level or basement level). In some embodiments, a location of the GPS receiver and/or an electronic device comprising the GPS receiver may also be expressed as an area or volume (defined either geodetically or in civic form) within which the GPS receiver is expected to be located with some probability or confidence level (e.g., 67%, 95%, etc.). In the description contained herein, the use of the term location may comprise any of these variants unless indicated otherwise. When computing the location of a GPS receiver, such computations may solve for local X, Y, and possibly Z coordinates and then, if needed, convert the coordinates from one coordinate frame to another.

Various aspects relate generally to wireless communications, and more particularly to mobile device positioning using RF signals. Some aspects more specifically relate to the use of differential carrier phase (DCP) measurements to maintain the accuracy of positioning observations obtained via an RTK positioning procedure in the absence of RTK correction data. According to some aspects, when RTK correction data is unavailable for a GNSS constellation, an RTK-based positioning engine can use highly-accurate relative positioning information embodied in DCP observations to obtain highly-accurate absolute positioning observations. In some examples, the RTK-based positioning engine can generate the DCP observations based on carrier phase observations. According to some aspects, the accuracy of the DCP observations may not depend on the accuracy of the carrier phase observations, and thus the RTK-based positioning engine may be able to obtain accurate DCP observations from the carrier phase observations when the carrier phase observations cannot be corrected due to the unavailability of the RTK correction data. By configuring the RTK-based positioning engine to use DCP measurements in this manner to produce highly-accurate positioning observations in the absence of RTK correction data, the overall positioning accuracy of the RTK-based positioning engine can be enhanced.

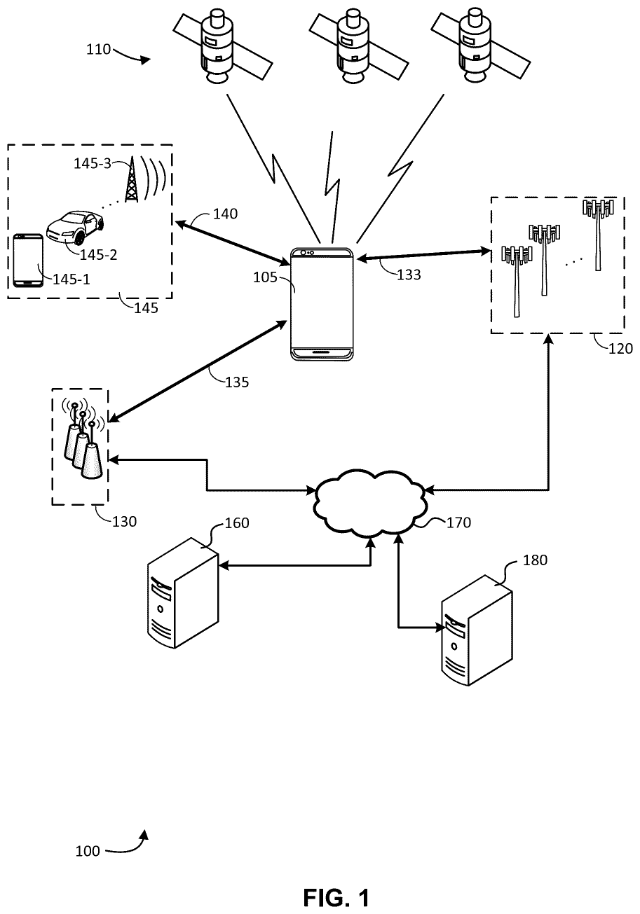

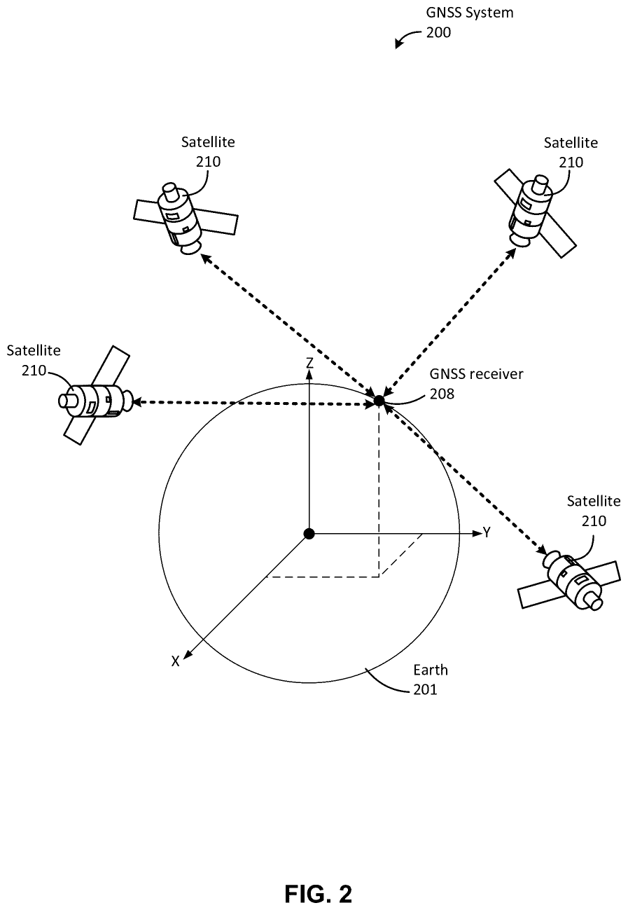

FIG. 1 is a simplified illustration of a positioning system 100 in which a mobile device 105, location server 160, and/or other components of the positioning system 100 can use the techniques provided herein for precise positioning using DCP-based measurement updates, according to an embodiment. The techniques described herein may be implemented by one or more components of the positioning system 100. The positioning system 100 can include: a mobile device 105; one or more satellites 110 (also referred to as space vehicles (SVs)) for a GNSS such as the GPS, GLONASS (GLO), Galileo (GAL), or BeiDou Navigation Satellite System (BDS) over China; base stations 120; access points (APs) 130; location server 160; network 170; and external client 180. Generally put, the positioning system 100 can estimate a location of the mobile device 105 based on radio frequency (RF) signals received by and/or sent from the mobile device 105 and known locations of other components (e.g., GNSS satellites 110, base stations 120, APs 130) transmitting and/or receiving the RF signals. Additional details regarding particular location estimation techniques are discussed in more detail with regard to FIG. 2.

In this example, FIG. 1 illustrates the mobile device 105 as a smartphone device, however, mobile devices may be any suitable device that includes GNSS capabilities or may be a device or machine into which such GNSS capabilities are integrated. Thus, a mobile device 105 may include personal devices such as a smartphone, smartwatch, tablet, laptop, etc. However, mobile devices may include a larger class of device as well and may include vehicles with integrated GNSS receivers and positioning systems, such as boats or ships, cars, trucks, aircraft, shipping containers, etc. As noted, in certain contexts, such as in reference to a cellular network, the mobile device 105 may be referred to as a UE.

It should be noted that FIG. 1 provides only a generalized illustration of various components, any or all of which may be utilized as appropriate, and each of which may be duplicated as necessary. Specifically, although only one mobile device 105 is illustrated, it will be understood that many mobile devices (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-cNB may be part of a Next Generation Radio Access Network (NG-RAN) which may connect to a 5G Core Network (5GC) in the case that Network 170 is a 5G network. The functionality performed by a base station 120 in earlier-generation networks (e.g., 3G and 4G) may be separated into different functional components (e.g., radio units (RUS), distributed units (DUs), and central units (CUs)) and layers (e.g., L1/L2/L3) in view Open Radio Access Networks (O-RAN) and/or Virtualized Radio Access Network (V-RAN or vRAN) in 5G or later networks, which may be executed on different devices at different locations connected, for example, via fronthaul, midhaul, and backhaul connections. As referred to herein, a “base station” (or ng-eNB, gNB, etc.) may include any or all of these functional components. An AP 130 may comprise a Wi-Fi AP or a Bluetooth® AP or an AP having cellular capabilities (e.g., 4G LTE and/or 5G NR), for example. Thus, mobile device 105 can send and receive information with network-connected devices, such as location server 160, by accessing the network 170 via a base station 120 using a first communication link 133. Additionally or alternatively, because APs 130 also may be communicatively coupled with the network 170, mobile device 105 may communicate with network-connected and Internet-connected devices, including location server 160, using a second communication link 135, or via one or more other mobile devices 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of mobile device 105 and/or provide data (e.g., “assistance data”) to mobile device 105 to facilitate location measurement and/or location determination by mobile device 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for mobile device 105 based on subscription information for mobile device 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of mobile device 105 using a control plane (CP) location solution for LTE radio access by mobile device 105. The location server 160 may further comprise a Location Management Function (LMF) that supports location of mobile device 105 using a control plane (CP) location solution for NR or LTE radio access by mobile device 105.

In a CP location solution, signaling to control and manage the location of mobile device 105 may be exchanged between elements of network 170 and with mobile device 105 using existing network interfaces and protocols and as signaling from the perspective of network 170. In a UP location solution, signaling to control and manage the location of mobile device 105 may be exchanged between location server 160 and mobile device 105 as data (e.g. data transported using the Internet Protocol (IP) and/or Transmission Control Protocol (TCP)) from the perspective of network 170.

As previously noted (and discussed in more detail below), the estimated location of mobile device 105 may be based on measurements of RF signals sent from and/or received by the mobile device 105. In particular, these measurements can provide information regarding the relative distance and/or angle of the mobile device 105 from one or more components in the positioning system 100 (e.g., GNSS satellites 110, APs 130, base stations 120). The estimated location of the mobile device 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the mobile device 105 may be estimated at least in part based on measurements of RF signals 140 communicated between the mobile device 105 and one or more other mobile devices 145, which may be mobile or fixed. As illustrated, other mobile devices may include, for example, a mobile phone 145-1, vehicle 145-2, and/or static communication/positioning device 145-3. When or more other mobile devices 145 are used in the position determination of a particular mobile device 105, the mobile device 105 for which the position is to be determined may be referred to as the “target mobile device,” and each of the one or more other mobile devices 145 used may be referred to as an “anchor mobile device.” For position determination of a target mobile device, the respective positions of the one or more anchor mobile devices may be known and/or jointly determined with the target mobile device. Direct communication between the one or more other mobile devices 145 and mobile device 105 may comprise sidelink and/or similar Device-to-Device (D2D) communication technologies. Sidelink, which is defined by 3GPP, is a form of D2D communication under the cellular-based LTE and NR standards.

According to some embodiments, such as when the mobile device 105 comprises and/or is incorporated into a vehicle, a form of D2D communication used by the mobile device 105 may comprise vehicle-to-everything (V2X) communication. V2X is a communication standard for vehicles and related entities to exchange information regarding a traffic environment. V2X can include vehicle-to-vehicle (V2V) communication between V2X-capable vehicles, vehicle-to-infrastructure (V2I) communication between the vehicle and infrastructure-based devices (commonly termed roadside units (RSUs)), vehicle-to-person (V2P) communication between vehicles and nearby people (pedestrians, cyclists, and other road users), and the like. Further, V2X can use any of a variety of wireless RF communication technologies. Cellular V2X (CV2X), for example, is a form of V2X that uses cellular-based communication such as LTE (4G), NR (5G) and/or other cellular technologies in a direct-communication mode as defined by 3GPP. The mobile device 105 illustrated in FIG. 1 may correspond with a component or device on a vehicle, RSU, or other V2X entity that is used to communicate V2X messages. The static communication/positioning device 145-3 (which may correspond with an RSU) and/or the vehicle 145-2, therefore, may communicate with the mobile device 105 and may be used to determine the position of the mobile device 105 using techniques similar to those used by base stations 120 and/or APs 130 (e.g., using multiangulation and/or multilateration). It can be further noted that mobile devices 145 (which may include V2X devices), base stations 120, and/or APs 130 may be used together (e.g., in a WWAN positioning solution) to determine the position of the mobile device 105, according to some embodiments.

An estimated location of mobile device 105 can be used in a variety of applications—e.g. to assist direction finding or navigation for a user of mobile device 105 or to assist another user (e.g. associated with external client 180) to locate mobile device 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of mobile device 105 may comprise an absolute location of mobile device 105 (e.g. a latitude and longitude and possibly altitude) or a relative location of mobile device 105 (e.g. a location expressed as distances north or south, cast or west and possibly above or below some other known fixed location (including, e.g., the location of a base station 120 or AP 130) or some other location such as a location for mobile device 105 at some known previous time, or a location of another mobile device 145 at some known previous time). As noted elsewhere herein, a location may be specified as a geodetic location comprising coordinates which may be absolute (e.g. latitude, longitude and optionally altitude), relative (e.g. relative to some known absolute location) or local (e.g. X. Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which mobile device 105 is expected to be located with some level of confidence (e.g. 95% confidence).

The external client 180 may be a web server or remote application that may have some association with mobile device 105 (e.g. may be accessed by a user of mobile device 105) or may be a server, application, or computer system providing a location service to some other user or users which may include obtaining and providing the location of mobile device 105 (e.g. to enable a service such as friend or relative finder, or child or pet location). Additionally or alternatively, the external client 180 may obtain and provide the location of mobile device 105 to an emergency services provider, government agency, etc.

As noted, the mobile device 105 of FIG. 1 may be capable of GNSS positioning. Details regarding GNSS positioning of a mobile device 105, or any device comprising a GNSS receiver, are provided hereafter with regard to FIG. 2.

FIG. 2 is a simplified diagram of a GNSS system 200, provided to illustrate how GNSS is generally used to determine an accurate location of a GNSS receiver 208 on earth 201. Put generally, the GNSS system 200 enables an accurate GNSS position fix of the GNSS receiver 208, which receives RF signals from GNSS satellites 210 from one or more GNSS constellations. The types of GNSS receiver 208 used may vary, depending on application. In some embodiments, for instance, the GNSS receiver 208 may comprise a standalone device or component incorporated into another device (e.g., mobile device 105 of FIG. 1). In some embodiments, the GNSS receiver 208 may be integrated into industrial or commercial equipment, such as survey equipment, Internet of Things (IoT) devices, etc.

It will be understood that the diagram provided in FIG. 2 is greatly simplified. In practice, there may be dozens of satellites 210 and a given GNSS constellation, and there are many different types of GNSS systems. As noted, GNSS systems include GPS, Galileo, GLONASS, or BDS. Additional GNSS systems include, for example, Quasi-Zenith Satellite System (QZSS) over Japan, Indian Regional Navigational Satellite System (IRNSS) over India, etc. In addition to the basic positioning functionality later described, GNSS augmentation (e.g., a Satellite Based Augmentation System (SBAS)) may be used to provide higher accuracy. Such augmentation may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

GNSS positioning is based on trilateration/multilateration, which is a method of determining position by measuring distances to points at known coordinates. In general, the determination of the position of a GNSS receiver 208 in three dimensions may rely on a determination of the distance between the GNSS receiver 208 and four or more satellites 210. As illustrated, 3D coordinates may be based on a coordinate system (e.g., XYZ coordinates; latitude, longitude, and altitude; etc.) centered at the earth's center of mass. A distance between each satellite 210 and the GNSS receiver 208 may be determined using precise measurements made by the GNSS receiver 208 of a difference in time from when a RF signal is transmitted from the respective satellite 210 to when it is received at the GNSS receiver 208. To help ensure accuracy, not only does the GNSS receiver 208 need to make an accurate determination of when the respective signal from each satellite 210 is received, but many additional factors need to be considered and accounted for. These factors include, for example, clock differences at the GNSS receiver 208 and satellite 210 (e.g., clock bias), a precise location of each satellite 210 at the time of transmission (e.g., as determined by the broadcast ephemeris), the impact of atmospheric distortion (e.g., ionospheric and tropospheric delays), and the like.

To perform a traditional GNSS position fix, the GNSS receiver 208 can use code-based positioning to determine its distance to each satellite 210 based on a determined delay in a generated pseudorandom binary sequence received in the RF signals received from each satellite, in consideration of the additional factors and error sources previously noted. With the distance and location information of the satellites 210, the GNSS receiver 208 can then determine a position fix for its location. This position fix may be determined, for example, by a Standalone Positioning Engine (SPE) executed by one or more processors of the GNSS receiver 208. However, code-based positioning is relatively inaccurate and, without error correction, and is subject to many of the previously described errors. Even so, code-based GNSS positioning can provide an positioning accuracy for the GNSS receiver 208 on the order of meters.

More accurate carrier-based ranging is based on a carrier wave of the RF signals received from each satellite, and may use measurements at a base or reference station (not shown) to perform error correction to help reduce errors from the previously noted error sources. More specifically, errors (e.g., atmospheric errors sources) in the carrier-based ranging of satellites 210 observed by the GNSS receiver 208 can be mitigated or canceled based on similar carrier-based ranging of the satellites 210 using a highly accurate GNSS receiver at the base station at a known location. These measurements and the base station's location can be provided to the GNSS receiver 208 for error correction. This position fix may be determined, for example, by a Precise Positioning Engine (PPE) executed by one or more processors of the GNSS receiver 208. More specifically, in addition to the information provided to an SPE, the PPE may use base station GNSS measurement information, and additional correction information, such as troposphere and ionosphere, to provide a high accuracy, carrier-based position fix. Several GNSS techniques can be adopted in PPE, such as Differential GNSS (DGNSS), Real Time Kinematic (RTK), and Precise Point Positioning (PPP), and may provide a sub-meter accuracy (e.g., on the order of centimeters). (An SPE and/or PPE may be referred to herein as a GNSS positioning engine, and may be incorporated into a broader positioning engine that uses other (non-GNSS) positioning sources.)

Multi-frequency GNSS receivers use satellite signals from different GNSS frequency bands (also referred to herein simply as “GNSS bands”) to determine desired information such as pseudoranges, position estimates, and/or time. Using multi-frequency GNSS may provide better performance (e.g., position estimate speed and/or accuracy) than single-frequency GNSS in many conditions. However, as discussed in more detail hereafter, using multi-frequency GNSS typically uses more power than single-frequency GNSS, e.g., processing power and battery power (e.g., to power a processor (e.g., for determining measurements), baseband processing, and/or RF processing).

Referring again to FIG. 2, the satellites 210 may be members of a single satellite constellation, i.e., a group of satellites that are part of a GNSS system, e.g., controlled by a common entity such as a government, and orbiting in complementary orbits to facilitate determining positions of entities around the world. One or more of the satellites 210 may transmit multiple satellite signals in different GNSS frequency bands, such as L1, L2, and/or L5 frequency bands. The terms L1 band, L2 band, and L5 band are used herein because these terms are used for GPS to refer to respective ranges of frequencies. Various receiver configurations may be used to receive satellite signals. For example, a receiver may use separate receive chains for different frequency bands. As another example, a receiver may use a common receive chain for multiple frequency bands that are close in frequency, for example L2 and L5 bands. As another example, a receiver may use separate receive chains for different signals in the same band, for example GPS L1 and GLONASS L1 sub-bands. A single receiver may use a combination of two or more of these examples. These configurations are examples, and other configurations are possible.

Multiple satellite bands are allocated to satellite usage. These bands include the L-band, used for GNSS satellite communications, the C-band, used for communications satellites such as television broadcast satellites, the X-band, used by the military and for RADAR applications, and the Ku-band (primarily downlink communication and the Ka-band (primarily uplink communications), the Ku and Ka bands used for communications satellites. The L-band is defined by IEEE as the frequency range from 1 to 2 GHZ. The L-Band is utilized by the GNSS satellite constellations such as GPS, Galileo, GLONASS, and BDS, and is broken into various bands, including L1, L2, and L5. For location purposes, the L1 band has historically been used by commercial GNSS receivers. However, measuring GNSS signals across more than one band may provide for improved accuracy and availability.

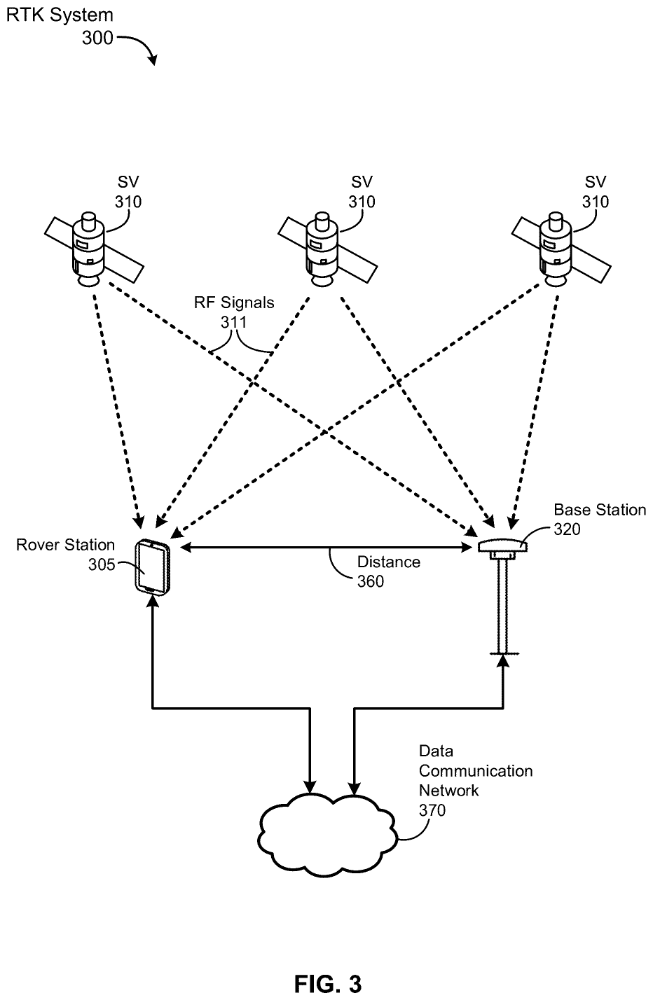

FIG. 3 is a simplified diagram of an RTK system 300, according to an embodiment. The RTK system 300 can generate RTK correction data that can be used to obtain high-accuracy positioning information based in GNSS measurements. The RTK system 300 can enable a highly accurate GNSS position fix of the rover station 305 using GNSS receivers at both the rover station 305 and base station 320 that receive RF signals 311 from satellite vehicles (SVs) 310 from one or more GNSS constellations (e.g., Global Position System (GPS), Galileo (GAL), Global Navigation Satellite System (GLONASS), Beidou, etc.). In an example, a GNSS receiver also includes a transceiver. The types of rover stations 305 used may vary, depending on application. In some embodiments, for instance, the rover station 305 may comprise consumer electronics or devices, such as a mobile phone, tablet, laptop, wearable device, vehicle, or the like. In some embodiments, the rover station 305 may comprise industrial equipment, such as survey equipment. In yet other embodiments, the rover station 305 can be integrated with equipment to provide various location-based functionalities, such as being integrated in vehicles, including autonomous ground, aerial, and maritime vehicles.

It can be further noted that, although the embodiment illustrated in FIG. 3 and additional embodiments described herein show the use of only a single base station 320, alternative embodiments may employ more than one base station 320. That is, according to some embodiments, the rover station 305 may employ RTK correction information from a plurality of base stations 320, individually and/or collectively. As such, it will be understood that references to “a base station” in the description of the embodiments herein may refer to one base station of a plurality of base stations.

To perform a traditional GNSS position fix, the rover station 305 can use code-based positioning to determine a distance of each of the SVs 310 based on a determined delay in a generated pseudorandom binary sequence received in the RF signals 311, and the resulting accuracy of the position fix for the rover station 305 is subject to errors caused by SV 310 orbit and clock, ionosphere and troposphere delays, and other phenomena. Although this can provide accuracy on the order of meters, this accuracy may be insufficient for many applications.

As noted, RTK can provide enhanced accuracy (e.g., on the order of centimeters or decimeters) by using carrier-based ranging based on the carrier phases of the RF signals 311 and using the base station 320 to help reduce errors from various error sources. The base station 320 comprises a fixed GNSS receiver that, using carrier-based ranging and known position, determines correction information to reduce the errors as described above (e.g., orbit and clock errors, ionosphere and troposphere delays, etc.). The correction information can then be provided to the rover station 305 via, for example, a data communication network 370, or via radio broadcast.

The RTK correction information can be valid when the distance 360 between rover station 305 and base station 320 does not exceed a threshold distance. That is, the RTK correction information can assumes similar errors (such as atmospheric errors) between base station 320 and rover station 305, based on the rover station 305 being within a threshold distance, or “baseline,” of the base station 320. If RTK system 300 includes just a single base station 320, the baseline may be on the order of 10-20 km. If multiple base stations 320 are included in RTK system 300, the baseline may be on the order of 40-50 km.

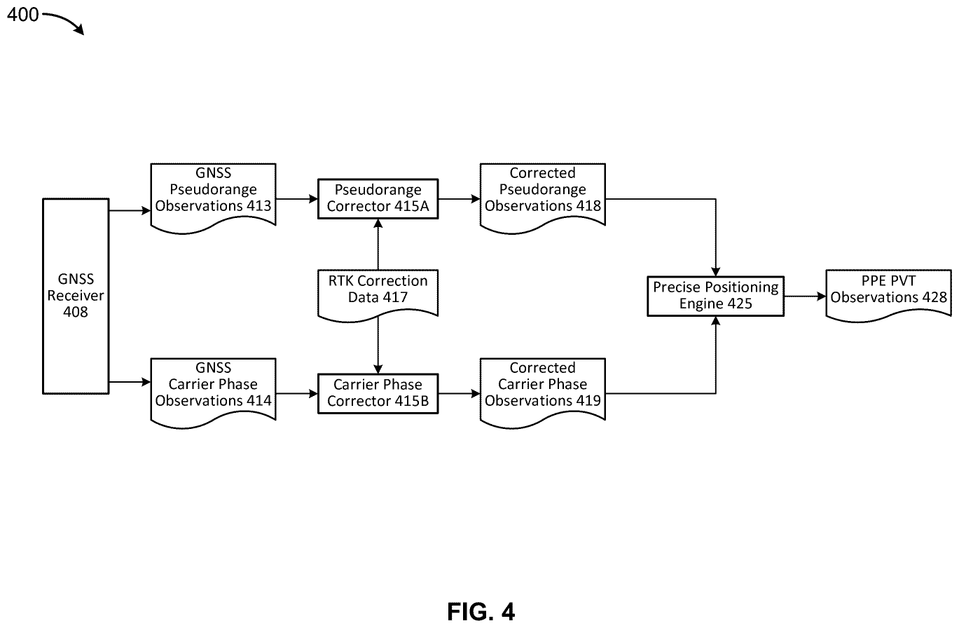

FIG. 4 is a block diagram illustrating an example positioning scheme 400, according to aspects of the disclosure. Positioning scheme 400 may be representative of an RTK-based positioning scheme, such as may be implemented in RTK system 300 of FIG. 3. According to positioning scheme 400, a GNSS receiver 408 measures GNSS signals to obtain GNSS pseudorange observations 413 and GNSS carrier phase observations 414. In various examples, the GNSS receiver 408 may be representative of a GNSS receiver of rover station 305 in RTK system 300 of FIG. 3. Based on RTK correction data 417, a pseudorange corrector 415A corrects GNSS pseudorange observations 413 to obtain corrected pseudorange observations 418, and a carrier phase corrector 415B corrects GNSS carrier phase observations 414 to obtain corrected carrier phase observations 419. In various examples, the RTK correction data 417 may be representative of correction data that base station 320 may provide to rover station 305 in RTK system 300 of FIG. 3. Based on corrected pseudorange observations 418 and corrected carrier phase observations 419, a precise positioning engine (PPE) 425 generates PPE position, velocity, and time (PVT) observations 428.

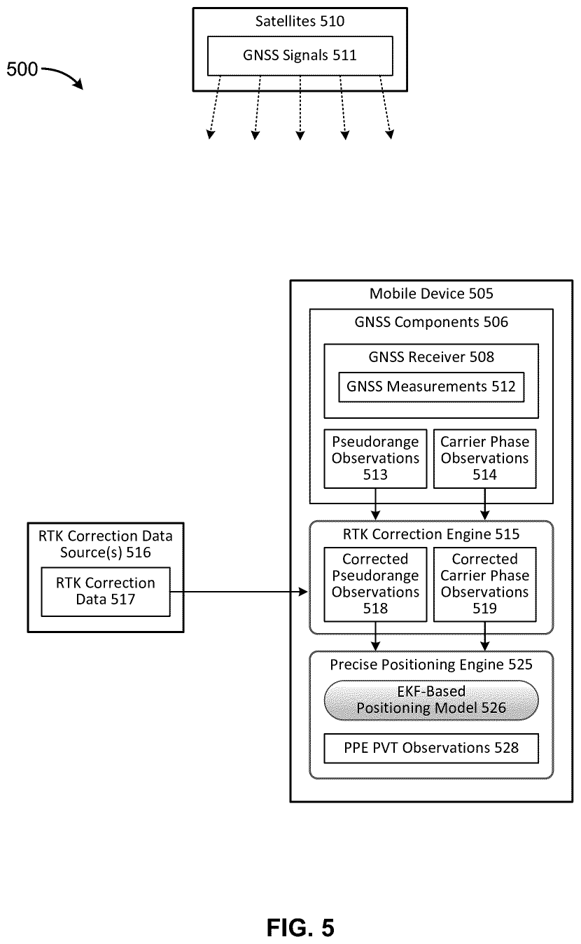

FIG. 5 is a block diagram illustrating an example operating environment 500 in which an RTK-based positioning scheme may be implemented according to aspects of the disclosure. In operating environment 500, a mobile device 505 obtains positioning estimates (in the form of PPE PVT observations 528) from a precise positioning engine 525 that applies an extended Kalman filter (EKF)-based positioning model 526 to implement the positioning scheme 400 of FIG. 4. In various examples, the mobile device 505 may correspond to the rover station 305 in RTK system 300 of FIG. 3.

The mobile device 505 includes GNSS components 506, which can provide the mobile device 505 with GNSS-based positioning capabilities that allow the mobile device 505 to conduct positioning based on GNSS signals 511 transmitted by satellites 510. The GNSS components 506 can include a GNSS receiver 508, which can measure received GNSS signals 511 to obtain GNSS measurements 512. Based on the GNSS measurements 512, the GNSS components 506 can generate pseudorange observations 513 and carrier phase observations 514. In various examples, the GNSS receiver 508, the pseudorange observations 513, and the carrier phase observations 514 can correspond to the GNSS receiver 408, the pseudorange observations 413, and the carrier phase observations 414 of the positioning scheme 400 of FIG. 4.

The mobile device 505 can execute—for example, using one or more included processors (not shown in FIG. 5)—an RTK correction engine 515. The RTK correction engine 515 can correct the pseudorange observations 513 and carrier phase observations 514 based on RTK correction data 517, to obtain corrected pseudorange observations 518 and corrected carrier phase observations 519, respectively. Mobile device 505 can receive the RTK correction data 517 from one or more RTK correction data sources 516. In various examples, the RTK correction engine 515 can perform the functions of the pseudorange corrector 415A and the carrier phase corrector 415B of the positioning scheme 400 of FIG. 4. In various examples, any particular one of RTK correction data sources 516 can correspond to the base station 320 in RTK system 300 of FIG. 3. In various examples, the RTK correction data 517, the corrected pseudorange observations 518, and the corrected carrier phase observations 519 can correspond to the RTK correction data 417, the corrected pseudorange observations 418, and the corrected carrier phase observations 419 of the positioning scheme 400 of FIG. 4.

The mobile device 505 can also execute—for example, using one or more included processors (not shown in FIG. 5)—a precise positioning engine (PPE) 525. The precise positioning engine 525 can implement EKF-based positioning model 526, according to which it can generate PPE PVT observations 528 based on the corrected pseudorange observations 518 and the corrected carrier phase observations 519.

In operating environment 500, if RTK correction data 517 is not available for a given GNSS constellation, then RTK correction engine 515 may be unable to apply corrections to pseudorange observations 513 and carrier phase observations 514 to obtain corrected pseudorange observations 518 and corrected carrier phase observations 519. As a result, the accuracy of the PPE PVT observations that precise positioning engine 525 generates may be suboptimal.

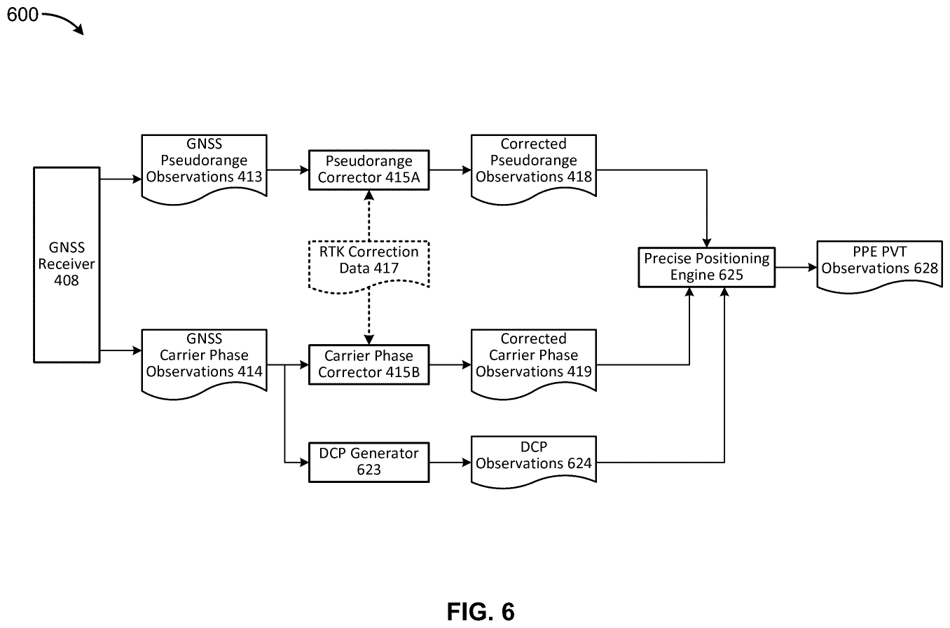

FIG. 6 is a block diagram illustrating an example positioning scheme 600, according to aspects of the disclosure. Positioning scheme 600 may be representative of the implementation of various techniques disclosed herein for precise positioning using DCP-based measurement updates. According to positioning scheme 600, a DCP generator 623 can generate DCP observations 624 based on the GNSS carrier phase observations 414 provided by the GNSS receiver 408. If RTK correction data 417 is unavailable, a precise positioning engine 625 may not have access to corrected pseudorange observations 418 and corrected carrier phase observations 419, but rather merely to GNSS pseudorange observations 413 and GNSS carrier phase observations 414. However, the DCP observations 624 may be highly accurate even if the GNSS carrier phase observations 414 are not, and the precise positioning engine 625 may be able to use highly-accurate relative positioning information embodied in the DCP observations 624 to generate highly-accurate PPE PVT observations 628. According to aspects of the disclosure, when RTK correction data 417 is available, the precise positioning engine 625 may use the highly-accurate relative positioning information embodied in the DCP observations 624 to enhance the accuracy of position estimation that it conducts based on the corrected pseudorange observations 418 and the corrected carrier phase observations 419.

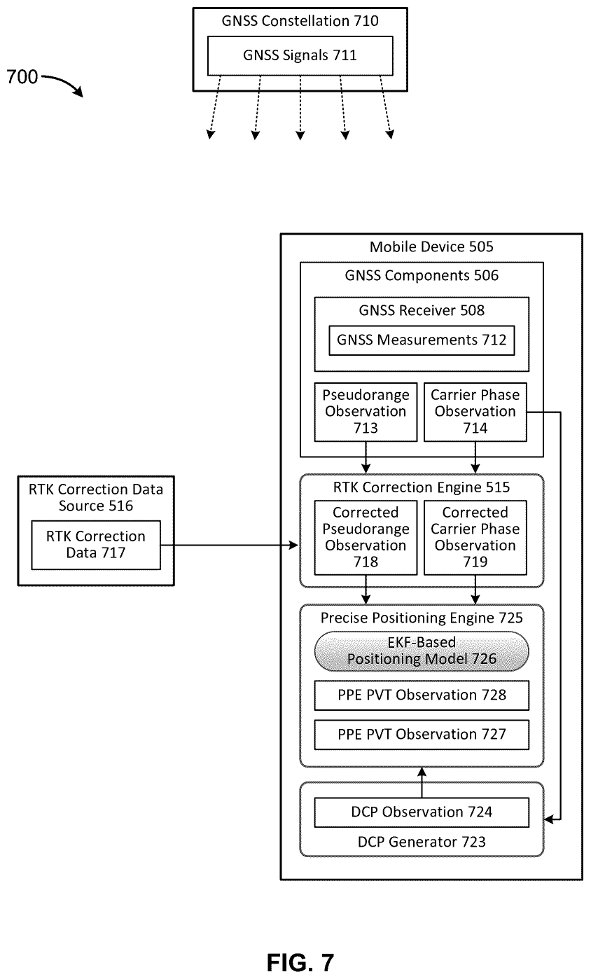

FIG. 7 is a block diagram illustrating an example operating environment 700 in which mobile device 505 may implement techniques for precise positioning using DCP-based measurement updates according to aspects of the disclosure. For instance, in some examples, mobile device 505 may implement positioning scheme 600 of FIG. 6 in operating environment 700 of FIG. 7. In operating environment 700, mobile device 505 can obtain a positioning estimate (in the form of a PPE PVT observation 728 for a positioning epoch Eⱼ) from a precise positioning engine 725 that applies an extended Kalman filter (EKF)-based positioning model 726 to implement the positioning scheme 600 of FIG. 6.

As shown in FIG. 7, the GNSS receiver 508 of mobile device 505 can measure received GNSS signals 711 of a GNSS constellation 710 to obtain GNSS measurements 712. In some examples, the GNSS constellation 710 can be a BeiDou Navigation Satellite System (BDS) constellation. In some other examples, the GNSS constellation 710 can be a Galileo constellation. In yet other examples, the GNSS constellation 710 can be a GPS constellation or a GLONASS constellation. Based on the GNSS measurements 712, the GNSS components 506 can generate, for the positioning epoch Eⱼ, a pseudorange observation 713 and a carrier phase observation 714. In various examples, the pseudorange observation 713 and the carrier phase observation 714 can correspond to respective ones of the pseudorange observations 413 and the carrier phase observations 414 of the positioning scheme 600 of FIG. 6.

According to aspects of the disclosure, the pseudorange observation 713 and the carrier phase observation 714 that the GNSS components 506 generate based on GNSS measurements 712 of GNSS signals 711 can be expressed mathematically according to Equations (1) and (2) as follows:

P_{f}=ρ+dT+ISTB_{f}+Trop+f₁²*dIono/f²+ε_{P}_{_{f}} (1)

Φ_{f}=ρ+dT+ISTB_{f}+Trop−f₁²*dIono/f²+λ_{f}(N_{f}+r_{f}−s_{f})+∈_{Φ}_{_{f}} (2)
where f is the frequency of the GNSS signals 711, P_{f} is a pseudorange observation, Φ_{f} is a carrier phase observation, p is a geometry range, dT is a clock error of the GNSS receiver 508, ISTB_{f} is an inter-signal time bias, Trop is a troposphere delay, dIono is an ionosphere delay residual error, ∈_{P}_{_{f}} is noise and multipath error, λ_{f} is the wavelength that corresponds to the frequency f, f₁ is the central frequency on the L1 band, N_{f} is an integer ambiguity term, r_{f} is an ambiguity receiver fractional bias term, and s_{f} is an ambiguity satellite fractional bias term.

In operating environment 700, if RTK correction data 717 associated with the GNSS constellation 710 is available, the RTK correction engine 515 may be able to correct pseudorange observation 713 and carrier phase observation 714 based on the RTK correction data 717, to obtain corrected pseudorange observation 718 and corrected carrier phase observation 719, respectively. In various examples, the RTK correction data 717 can correspond to the RTK correction data 417 of the positioning scheme 600 of FIG. 6, and the corrected pseudorange observation 718 and the corrected carrier phase observation 719 can correspond to respective ones of the corrected pseudorange observations 418 and the corrected carrier phase observations 419 of the positioning scheme 600 of FIG. 6.

According to aspects of the disclosure, in operating environment 700, mobile device 505 can execute—for example, using one or more included processors (not shown in FIG. 7)—a precise positioning engine (PPE) 725. The precise positioning engine 725 can implement EKF-based positioning model 726. According to the EKF-based positioning model 726, the precise positioning engine 725 can conduct position estimation using an extended Kalman filter (EKF). The position estimation using the EKF can be described mathematically by Equations (3) and (4) as follows:

$${x}_{tj}^{-} = {φ}_{tj} {x}_{ti} \qquad ( 3 )$$

$${P}_{tj}^{-} = {φ}_{tj} {P}_{ti} {φ}_{tj}^{T} + {Q}_{tj} \qquad ( 4 )$$

where xₜⱼ⁻ is an estimation state vector for a GNSS epoch j, φₜⱼ is a state transition matrix for the epoch j, xₜᵢ is a state vector for a preceding epoch i, Pₜⱼ⁻ is an estimated variance-covariance matrix for the estimation state vector xₜⱼ⁻, Pₜᵢ is a variance-covariance matrix for the state vector xₜᵢ, T represents the transpose operation, and Qₜⱼ is a process noise covariance matrix for the epoch j.

In operating environment 700, if RTK correction data 717 is available, and thus RTK correction engine 515 can provide precise positioning engine 725 with the corrected pseudorange observation 718 and the corrected carrier phase observation 719, then precise positioning engine 725 can generate the PPE PVT observation 728 for the positioning epoch Eⱼ based on the corrected pseudorange observation 718 and the corrected carrier phase observation 719. However, if RTK correction data 717 is not available, precise positioning engine 725 may not be provided with the corrected pseudorange observation 718 and the corrected carrier phase observation 719, and may thus not be able to use them to generate the PPE PVT observation 728 for the positioning epoch Eⱼ.

According to aspects of the disclosure, if RTK correction data associated with a given GNSS constellation is not available, the precise positioning engine 725 can use differential carrier phase (DCP) observations associated with that constellation to generate accurate PPE PVT observations. In the example depicted in FIG. 7, if RTK correction data 717 associated with GNSS constellation 710 is not available, the precise positioning engine 725 can use a DCP observation 724 associated with the GNSS constellation 710 to generate an accurate PPE PVT observation 728 for the positioning epoch Eⱼ. As shown in FIG. 7, the mobile device 505 can execute—for example, using one or more included processors (not shown in FIG. 7)—a DCP generator 723, which can generate the DCP observation 724 based on carrier phase observation 714. According to aspects of the disclosure, the precise positioning engine 725 can generate the PPE PVT observation 728 for the positioning epoch Eⱼ based on the DCP observation 724 and a PPE PVT observation 727 for a preceding positioning epoch Eⱼ. In some examples, the precise positioning engine 725 can make use of the DCP observation 724 in generating the PPE PVT observation 728 even if the RTK correction data 517 associated with the GNSS constellation 710 is available. For instance, in some examples, the precise positioning engine 725 may generate the PPE PVT observation 728 for the positioning epoch Eⱼ based on corrected pseudorange observation 718, corrected carrier phase observation 719, the PPE PVT observation 727 for the preceding positioning epoch Eᵢ, and the DCP observation 724.

According to aspects of the disclosure, the EKF-based positioning model 726 can be tailored to provide for the potential use of DCP observations to generate PPE PVT observations as described above. In some examples, an estimation state of the EKF-based positioning model 726 (such as may be represented by the estimation state vector xₜⱼ⁻ of Equations (3) and (4)) can include both a current epoch position term and a previous epoch position term. In some examples, the estimation state can include both a current epoch clock term and a previous epoch clock term.

According to aspects of the disclosure, the EKF-based positioning model 726 can implement special handling of the current epoch clock term following DCP updates to account for the DCP observations being derived based on local device measurements in the absence of RTK correction data 717. In some examples, DCP updates can be based on rover clock deltas only, and rover-base clock deltas can otherwise be used. In some examples, the variance associated with the current epoch clock term can be increased prior to pseudorange/carrier phase updates. In some examples, a DCP measurement update can be conducted based on a selection of a reference SV, and can involve no update to the clock. In some such examples, a state update matrix for the DCP measurement update can include a current epoch position delta term and a previous epoch position delta term, but no current epoch clock delta term or previous epoch clock delta term.

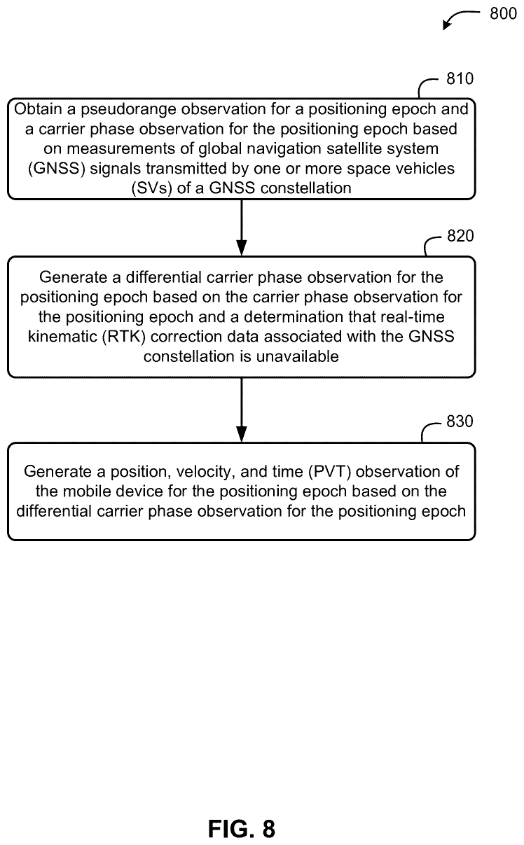

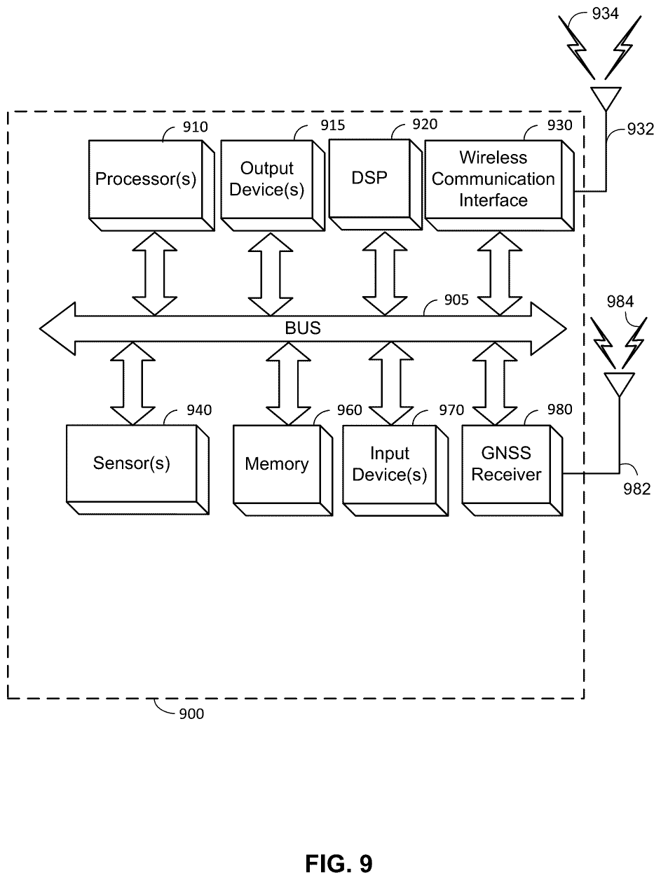

FIG. 8 is a block diagram illustrating an example positioning method 800, according to aspects of the disclosure. According to aspects of the disclosure, means for performing the functionality illustrated in one or more of the blocks shown in FIG. 8 may be performed by hardware and/or software components of a mobile device. Example components of a mobile device are illustrated in FIG. 9, which is described in more detail below. In some examples, mobile device 505 may perform the functionality illustrated in one or more of the blocks shown in FIG. 8 in operating environment 700 of FIG. 7.

At block 810, the functionality comprises obtaining a pseudorange observation for a positioning epoch and a carrier phase observation for the positioning epoch based on measurements of GNSS signals transmitted by one or more SVs of a GNSS constellation. For example, in operating environment 700 of FIG. 7, the GNSS components 506 can obtain pseudorange observation 713 and carrier phase observation 714 based on measurements of GNSS signals 511 transmitted by one or more satellites 510 associated with a GNSS constellation. Means for performing functionality at block 810 may comprise a bus 905, processor(s) 910, digital signal processor (DSP) 920, memory 960, GNSS receiver 980, and/or other components of a mobile device, as illustrated in FIG. 9. In some examples, the GNSS constellation can be a BeiDou Navigation Satellite System (BDS) constellation. In some other examples, the GNSS constellation can be a Galileo constellation. In yet other examples, the GNSS constellation can be a GPS constellation or a GLONASS constellation.

At block 820, the functionality comprises generating a differential carrier phase observation for the positioning epoch based on the carrier phase observation for the positioning epoch and a determination that RTK correction data associated with the GNSS constellation is unavailable. For example, in operating environment 700 of FIG. 7, the DCP generator 723 can generate DCP observation 724 based on carrier phase observation 714 and a determination that RTK correction data 717 associated with GNSS constellation 710 is unavailable. Means for performing functionality at block 830 may comprise a bus 905, processor(s) 910, digital signal processor (DSP) 920, memory 960, GNSS receiver 980, and/or other components of a mobile device, as illustrated in FIG. 9.

In some examples, the pseudorange observation for the positioning epoch can be discarded in response to the determination that the RTK correction data associated with the GNSS constellation data is unavailable and a determination that a residual error associated with the pseudorange observation for the positioning epoch exceeds a threshold. For instance, in the absence of RTK correction data, a pseudorange observation obtained based on GLONASS signal measurements may be discarded when an inability to calibrate GLONASS inter-frequency biases results in the pseudorange observation having an associated residual error that is large (for example, in the tens of meters) and exceeds a threshold (such as one meter, for example).

At block 830, the functionality comprises generating a PVT observation of the mobile device for the positioning epoch based on the differential carrier phase observation for the positioning epoch. For example, in operating environment 700 of FIG. 7, the precise positioning engine 725 can generate PPE PVT observation 728 based on DCP observation 724. Means for performing functionality at block 840 may comprise a bus 905, processor(s) 910, digital signal processor (DSP) 920, memory 960, GNSS receiver 980, and/or other components of a mobile device, as illustrated in FIG. 9.

According to aspects of the disclosure, the PVT observation of the mobile device for the positioning epoch can be generated based on the DCP observation for the positioning epoch and a PVT observation of the mobile device for a preceding positioning epoch. For example, in operating environment 700 of FIG. 7, the precise positioning engine 725 can generate the PPE PVT observation 728 based on the DCP observation 724 and the PPE PVT observation 727. According to aspects of the disclosure, the PVT observation of the mobile device for the positioning epoch can be generated according to an EKF-based positioning model. For example, in operating environment 700 of FIG. 7, the precise positioning engine 725 can generate the PPE PVT observation 728 according to the EKF-based positioning model 726. In some examples, an estimation state of the EKF-based positioning model can include a current epoch position term and a previous epoch position term. In some examples, the estimation state of the EKF-based positioning model can additionally or alternatively include a current epoch clock term and a previous epoch clock term. According to aspects of the disclosure, generating the PVT observation of the mobile device for the positioning epoch according to the EKF-based positioning model can include conducting a differential carrier phase measurement update based on a selection of a reference SV, where the differential carrier phase measurement update does not include updating a clock term.

In some examples, a pseudorange observation for a second positioning epoch and a carrier phase observation for the second positioning epoch can be obtained based on measurements of GNSS signals transmitted by one or more SVs of a second GNSS constellation, and it can be determined that RTK correction data associated with the second GNSS constellation is available. According to aspects of the disclosure, a corrected pseudorange observation and a corrected carrier phase observation can be generated based on the pseudorange observation for the second positioning epoch, the carrier phase observation for the second positioning epoch, and the RTK correction data associated with the second GNSS constellation. In some examples the RTK correction data associated with the second GNSS constellation can be obtained from one or more base stations.

According to aspects of the disclosure, a DCP observation for the second positioning epoch can be generated based on the carrier phase observation for the second positioning epoch, and a PVT observation of the mobile device for the second positioning epoch can be generated based on the corrected pseudorange observation, the corrected carrier phase observation, and the differential carrier phase observation for the second positioning epoch. In some examples, the PVT observation of the mobile device for the second positioning epoch can be generated based on the corrected pseudorange observation, the corrected carrier phase observation, the differential carrier phase observation for the second positioning epoch, and a PVT observation of the mobile device for a positioning epoch preceding the second positioning epoch.

FIG. 9 is a block diagram of an embodiment of a mobile device 900, which can be utilized as described herein above (e.g., in association with FIGS. 1-8). For example, the mobile device 900 can be used to implement one or more of mobile device 105 of FIG. 1, rover station 305 of FIG. 3, and mobile device 505 of FIGS. 5 and 7. In some examples, mobile device 800 can perform one or more operations associated with one or more of positioning scheme 400 of FIG. 4, positioning scheme 600 of FIG. 6, and positioning method 800 of FIG. 8. It should be noted that FIG. 9 is meant only to provide a generalized illustration of various components, any or all of which may be utilized as appropriate. It can be noted that, in some instances, components illustrated by FIG. 9 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 9.

The mobile device 900 is shown comprising hardware elements that can be electrically coupled via a bus 905 (or may otherwise be in communication, as appropriate). The hardware elements may include a processor(s) 910 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 910 may comprise one or more processing units, which may be housed in a single integrated circuit (IC) or multiple ICs. As shown in FIG. 9, some embodiments may have a separate DSP 920, depending on desired functionality. Location determination and/or other determinations based on wireless communication may be provided in the processor(s) 910 and/or wireless communication interface 930 (discussed below). The mobile device 900 also can include one or more input devices 970, which can include without limitation one or more keyboards, touch screens, touch pads, microphones, buttons, dials, switches, and/or the like; and one or more output devices 915, which can include without limitation one or more displays (e.g., touch screens), light emitting diodes (LEDs), speakers, and/or the like.

The mobile device 900 may also include a wireless communication interface 930, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the mobile device 900 to communicate with other devices as described in the embodiments above. The wireless communication interface 930 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 932 that send and/or receive wireless signals 934. According to some embodiments, the wireless communication antenna(s) 932 may comprise a plurality of discrete antennas, antenna arrays, or any combination thereof. The antenna(s) 932 may be capable of transmitting and receiving wireless signals using beams (e.g., Tx beams and Rx beams). Beam formation may be performed using digital and/or analog beam formation techniques, with respective digital and/or analog circuitry. The wireless communication interface 930 may include such circuitry.

Depending on desired functionality, the wireless communication interface 930 may comprise a separate receiver and transmitter, or any combination of transceivers, transmitters, and/or receivers to communicate with base stations (e.g., ng-eNBs and gNBs) and other terrestrial transceivers, such as wireless devices and access points. The mobile device 900 may communicate with different data networks that may comprise various network types. For example, a WWAN may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000®, WCDMA, and so on. CDMA2000® includes IS-95. IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR. LTE, LTE Advanced, GSM, and WCDMA are described in documents from 3GPP. CDMA2000® is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The mobile device 900 can further include sensor(s) 940. Sensor(s) 940 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the mobile device 900 may also include a Global Navigation Satellite System (GNSS) receiver 980 capable of receiving signals 984 from one or more GNSS satellites using an antenna 982 (which could be the same as antenna 932). Positioning based on GNSS signal measurement can be utilized to complement and/or incorporate the techniques described herein. The GNSS receiver 980 can extract a position of the mobile device 900, using conventional techniques, from GNSS satellites of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 980 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 980 is illustrated in FIG. 9 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 910, DSP 920, and/or a processor within the wireless communication interface 930 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), particle filter, or the like. The positioning engine may also be executed by one or more processors, such as processor(s) 910 or DSP 920.

The mobile device 900 may further include and/or be in communication with a memory 960. The memory 960 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 960 of the mobile device 900 also can comprise software elements (not shown in FIG. 9), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 960 that are executable by the mobile device 900 (and/or processor(s) 910 or DSP 920 within mobile device 900). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:
Clause 1. A positioning method for a mobile device, including obtaining a pseudorange observation for a positioning epoch and a carrier phase observation for the positioning epoch based on measurements of global navigation satellite system (GNSS) signals transmitted by one or more space vehicles (SVs) of a GNSS constellation, generating a differential carrier phase observation for the positioning epoch based on the carrier phase observation for the positioning epoch and a determination that real-time kinematic (RTK) correction data associated with the GNSS constellation is unavailable, and generating a position, velocity, and time (PVT) observation of the mobile device for the positioning epoch based on the differential carrier phase observation for the positioning epoch.
Clause 2. The positioning method of clause 1, further including generating the PVT observation of the mobile device for the positioning epoch based on the differential carrier phase observation for the positioning epoch and a PVT observation of the mobile device for a preceding positioning epoch.
Clause 3. The positioning method of any of clauses 1 to 2, further including discarding the pseudorange observation for the positioning epoch in response to the determination that the RTK correction data associated with the GNSS constellation is unavailable and a determination that a residual error associated with the pseudorange observation for the positioning epoch exceeds a threshold.
Clause 4. The positioning method of any of clauses 1 to 3, further including generating the PVT observation of the mobile device for the positioning epoch according to an extended Kalman filter (EKF)-based positioning model.
Clause 5. The positioning method of clause 4, where an estimation state of the EKF-based positioning model includes a current epoch position term and a previous epoch position term.
Clause 6. The positioning method of any of clauses 4 to 5, where an estimation state of the EKF-based positioning model includes a current epoch clock term and a previous epoch clock term.
Clause 7. The positioning method of any of clauses 4 to 6, where generating the PVT observation of the mobile device for the positioning epoch according to the EKF-based positioning model includes conducting a differential carrier phase measurement update based on a selection of a reference SV, where the differential carrier phase measurement update does not include updating a clock term.
Clause 8. The positioning method of any of clauses 1 to 7, further including obtaining a pseudorange observation for a second positioning epoch and a carrier phase observation for the second positioning epoch based on measurements of GNSS signals transmitted by one or more SVs of a second GNSS constellation, determining that RTK correction data associated with the second GNSS constellation is available, generating a corrected pseudorange observation and a corrected carrier phase observation based on the pseudorange observation for the second positioning epoch, the carrier phase observation for the second positioning epoch, and the RTK correction data associated with the second GNSS constellation, generating a differential carrier phase observation for the second positioning epoch based on the carrier phase observation for the second positioning epoch, and generating a PVT observation of the mobile device for the second positioning epoch based on the corrected pseudorange observation, the corrected carrier phase observation, and the differential carrier phase observation for the second positioning epoch.
Clause 9. The positioning method of clause 8, further including generating the PVT observation of the mobile device for the second positioning epoch based on the corrected pseudorange observation, the corrected carrier phase observation, the differential carrier phase observation for the second positioning epoch, and a PVT observation of the mobile device for a positioning epoch preceding the second positioning epoch.
Clause 10. The positioning method of any of clauses 8 to 9, further including obtaining the RTK correction data associated with the second GNSS constellation from one or more base stations.
Clause 11. The positioning method of any of clauses 1 to 10, where the GNSS constellation is a BeiDou Navigation Satellite System (BDS) constellation or a Galileo constellation.
Clause 12. A positioning apparatus for a mobile device, including a global navigation satellite system (GNSS) receiver, a memory, and one or more processors communicatively coupled with the GNSS receiver and the memory, where the one or more processors are configured to obtain a pseudorange observation for a positioning epoch and a carrier phase observation for the positioning epoch based on measurements of GNSS signals transmitted by one or more space vehicles (SVs) of a GNSS constellation, generate a differential carrier phase observation for the positioning epoch based on the carrier phase observation for the positioning epoch and a determination that real-time kinematic (RTK) correction data associated with the GNSS constellation is unavailable, and generate a position, velocity, and time (PVT) observation of the mobile device for the positioning epoch based on the differential carrier phase observation for the positioning epoch.
Clause 13. The positioning apparatus of clause 12, where the one or more processors are further configured to generate the PVT observation of the mobile device for the positioning epoch based on the differential carrier phase observation for the positioning epoch and a PVT observation of the mobile device for a preceding positioning epoch.
Clause 14. The positioning apparatus of any of clauses 12 to 13, where the one or more processors are further configured to discard the pseudorange observation for the positioning epoch in response to the determination that the RTK correction data associated with the GNSS constellation is unavailable and a determination that a residual error associated with the pseudorange observation for the positioning epoch exceeds a threshold.
Clause 15. The positioning apparatus of any of clauses 12 to 14, where the one or more processors are further configured to generate the PVT observation of the mobile device for the positioning epoch according to an extended Kalman filter (EKF)-based positioning model.
Clause 16. The positioning apparatus of clause 15, where an estimation state of the EKF-based positioning model includes a current epoch position term and a previous epoch position term.
Clause 17. The positioning apparatus of any of clauses 15 to 16, where an estimation state of the EKF-based positioning model includes a current epoch clock term and a previous epoch clock term.
Clause 18. The positioning apparatus of any of clauses 15 to 17, where generating the PVT observation of the mobile device for the positioning epoch according to the EKF-based positioning model includes conducting a differential carrier phase measurement update based on a selection of a reference SV, where the differential carrier phase measurement update does not include updating a clock term.
Clause 19. The positioning apparatus of any of clauses 12 to 18, where the one or more processors are further configured to obtain a pseudorange observation for a second positioning epoch and a carrier phase observation for the second positioning epoch based on measurements of GNSS signals transmitted by one or more SVs of a second GNSS constellation, determine that RTK correction data associated with the second GNSS constellation is available, generate a corrected pseudorange observation and a corrected carrier phase observation based on the pseudorange observation for the second positioning epoch, the carrier phase observation for the second positioning epoch, and the RTK correction data associated with the second GNSS constellation, generate a differential carrier phase observation for the second positioning epoch based on the carrier phase observation for the second positioning epoch, and generate a PVT observation of the mobile device for the second positioning epoch based on the corrected pseudorange observation, the corrected carrier phase observation, and the differential carrier phase observation for the second positioning epoch.
Clause 20. The positioning apparatus of clause 19, where the one or more processors are further configured to generate the PVT observation of the mobile device for the second positioning epoch based on the corrected pseudorange observation, the corrected carrier phase observation, the differential carrier phase observation for the second positioning epoch, and a PVT observation of the mobile device for a positioning epoch preceding the second positioning epoch.
Clause 21. The positioning apparatus of any of clauses 19 to 20, where the one or more processors are further configured to obtain the RTK correction data associated with the second GNSS constellation from one or more base stations.
Clause 22. The positioning apparatus of any of clauses 12 to 21, where the GNSS constellation is a BeiDou Navigation Satellite System (BDS) constellation or a Galileo constellation.
Clause 23. A non-transitory computer-readable medium storing instructions for positioning for a mobile device, the instructions including code for obtaining a pseudorange observation for a positioning epoch and a carrier phase observation for the positioning epoch based on measurements of global navigation satellite system (GNSS) signals transmitted by one or more space vehicles (SVs) of a GNSS constellation, generating a differential carrier phase observation for the positioning epoch based on the carrier phase observation for the positioning epoch and a determination that real-time kinematic (RTK) correction data associated with the GNSS constellation is unavailable, and generating a position, velocity, and time (PVT) observation of the mobile device for the positioning epoch based on the differential carrier phase observation for the positioning epoch.
Clause 24. The non-transitory computer-readable medium of clause 23, the instructions further including code for generating the PVT observation of the mobile device for the positioning epoch based on the differential carrier phase observation for the positioning epoch and a PVT observation of the mobile device for a preceding positioning epoch.
Clause 25. The non-transitory computer-readable medium of any of clauses 23 to 24, the instructions further including code for discarding the pseudorange observation for the positioning epoch in response to the determining that the RTK correction data associated with the GNSS constellation is unavailable and a determination that a residual error associated with the pseudorange observation for the positioning epoch exceeds a threshold.
Clause 26. The non-transitory computer-readable medium of any of clauses 23 to 25, the instructions further including code for generating the PVT observation of the mobile device for the positioning epoch according to an extended Kalman filter (EKF)-based positioning model.
Clause 27. The non-transitory computer-readable medium of clause 26, where an estimation state of the EKF-based positioning model includes a current epoch position term and a previous epoch position term.
Clause 28. The non-transitory computer-readable medium of any of clauses 26 to 27, where an estimation state of the EKF-based positioning model includes a current epoch clock term and a previous epoch clock term.
Clause 29. The non-transitory computer-readable medium of any of clauses 26 to 28, where generating the PVT observation of the mobile device for the positioning epoch according to the EKF-based positioning model includes conducting a differential carrier phase measurement update based on a selection of a reference SV, where the differential carrier phase measurement update does not include updating a clock term.
Clause 30. The non-transitory computer-readable medium of any of clauses 23 to 29, the instructions further including code for obtaining a pseudorange observation for a second positioning epoch and a carrier phase observation for the second positioning epoch based on measurements of GNSS signals transmitted by one or more SVs of a second GNSS constellation, determining that RTK correction data associated with the second GNSS constellation is available, generating a corrected pseudorange observation and a corrected carrier phase observation based on the pseudorange observation for the second positioning epoch, the carrier phase observation for the second positioning epoch, and the RTK correction data associated with the second GNSS constellation, generating a differential carrier phase observation for the second positioning epoch based on the carrier phase observation for the second positioning epoch, and generating a PVT observation of the mobile device for the second positioning epoch based on the corrected pseudorange observation, the corrected carrier phase observation, and the differential carrier phase observation for the second positioning epoch.
Clause 31. The non-transitory computer-readable medium of clause 30, the instructions further including code for generating the PVT observation of the mobile device for the second positioning epoch based on the corrected pseudorange observation, the corrected carrier phase observation, the differential carrier phase observation for the second positioning epoch, and a PVT observation of the mobile device for a positioning epoch preceding the second positioning epoch.
Clause 32. The non-transitory computer-readable medium of any of clauses 30 to 31, the instructions further including code for obtaining the RTK correction data associated with the second GNSS constellation from one or more base stations.
Clause 33. The non-transitory computer-readable medium of any of clauses 23 to 32, where the GNSS constellation is a BeiDou Navigation Satellite System (BDS) constellation or a Galileo constellation.
Clause 34. A positioning apparatus for a mobile device, including means for obtaining a pseudorange observation for a positioning epoch and a carrier phase observation for the positioning epoch based on measurements of global navigation satellite system (GNSS) signals transmitted by one or more space vehicles (SVs) of a GNSS constellation, means for generating a differential carrier phase observation for the positioning epoch based on the carrier phase observation for the positioning epoch and a determination that real-time kinematic (RTK) correction data associated with the GNSS constellation is unavailable, and means for generating a position, velocity, and time (PVT) observation of the mobile device for the positioning epoch based on the differential carrier phase observation for the positioning epoch.
Clause 35. The positioning apparatus of clause 34, further including means for generating the PVT observation of the mobile device for the positioning epoch based on the differential carrier phase observation for the positioning epoch and a PVT observation of the mobile device for a preceding positioning epoch.
Clause 36. The positioning apparatus of any of clauses 34 to 35, further including means for discarding the pseudorange observation for the positioning epoch in response to the determining that the RTK correction data associated with the GNSS constellation is unavailable and a determination that a residual error associated with the pseudorange observation for the positioning epoch exceeds a threshold.
Clause 37. The positioning apparatus of any of clauses 34 to 36, further including means for generating the PVT observation of the mobile device for the positioning epoch according to an extended Kalman filter (EKF)-based positioning model.
Clause 38. The positioning apparatus of clause 37, where an estimation state of the EKF-based positioning model includes a current epoch position term and a previous epoch position term.
Clause 39. The positioning apparatus of any of clauses 37 to 38, where an estimation state of the EKF-based positioning model includes a current epoch clock term and a previous epoch clock term.
Clause 40. The positioning apparatus of any of clauses 37 to 39, where generating the PVT observation of the mobile device for the positioning epoch according to the EKF-based positioning model includes conducting a differential carrier phase measurement update based on a selection of a reference SV, where the differential carrier phase measurement update does not include updating a clock term.
Clause 41. The positioning apparatus of any of clauses 34 to 40, further including means for obtaining a pseudorange observation for a second positioning epoch and a carrier phase observation for the second positioning epoch based on measurements of GNSS signals transmitted by one or more SVs of a second GNSS constellation, means for determining that RTK correction data associated with the second GNSS constellation is available, means for generating a corrected pseudorange observation and a corrected carrier phase observation based on the pseudorange observation for the second positioning epoch, the carrier phase observation for the second positioning epoch, and the RTK correction data associated with the second GNSS constellation, means for generating a differential carrier phase observation for the second positioning epoch based on the carrier phase observation for the second positioning epoch, and means for generating a PVT observation of the mobile device for the second positioning epoch based on the corrected pseudorange observation, the corrected carrier phase observation, and the differential carrier phase observation for the second positioning epoch.
Clause 42. The positioning apparatus of clause 41, further including means for generating the PVT observation of the mobile device for the second positioning epoch based on the corrected pseudorange observation, the corrected carrier phase observation, the differential carrier phase observation for the second positioning epoch, and a PVT observation of the mobile device for a positioning epoch preceding the second positioning epoch.
Clause 43. The positioning apparatus of any of clauses 41 to 42, further including means for obtaining the RTK correction data associated with the second GNSS constellation from one or more base stations.
Clause 44. The positioning apparatus of any of clauses 34 to 43, where the GNSS constellation is a BeiDou Navigation Satellite System (BDS) constellation or a Galileo constellation.

What is claimed is:

1. A positioning method for a mobile device, comprising:
obtaining a pseudorange observation for a positioning epoch and a carrier phase observation for the positioning epoch based on measurements of global navigation satellite system (GNSS) signals transmitted by one or more space vehicles (SVs) of a GNSS constellation;
generating a differential carrier phase observation for the positioning epoch based on the carrier phase observation for the positioning epoch and a determination that real-time kinematic (RTK) correction data associated with the GNSS constellation is unavailable; and
generating a position, velocity, and time (PVT) observation of the mobile device for the positioning epoch based on the differential carrier phase observation for the positioning epoch.

2. The positioning method of claim 1, further comprising generating the PVT observation of the mobile device for the positioning epoch based on the differential carrier phase observation for the positioning epoch and a PVT observation of the mobile device for a preceding positioning epoch.

3. The positioning method of claim 1, further comprising discarding the pseudorange observation for the positioning epoch in response to the determination that the RTK correction data associated with the GNSS constellation is unavailable and a determination that a residual error associated with the pseudorange observation for the positioning epoch exceeds a threshold.

4. The positioning method of claim 1, further comprising generating the PVT observation of the mobile device for the positioning epoch according to an extended Kalman filter (EKF)-based positioning model.

5. The positioning method of claim 4, wherein an estimation state of the EKF-based positioning model includes a current epoch position term and a previous epoch position term.

6. The positioning method of claim 4, wherein an estimation state of the EKF-based positioning model includes a current epoch clock term and a previous epoch clock term.

7. The positioning method of claim 4, wherein generating the PVT observation of the mobile device for the positioning epoch according to the EKF-based positioning model includes conducting a differential carrier phase measurement update based on a selection of a reference SV, wherein the differential carrier phase measurement update does not include updating a clock term.

8. The positioning method of claim 1, further comprising:
obtaining a pseudorange observation for a second positioning epoch and a carrier phase observation for the second positioning epoch based on measurements of GNSS signals transmitted by one or more SVs of a second GNSS constellation;
determining that RTK correction data associated with the second GNSS constellation is available;
generating a corrected pseudorange observation and a corrected carrier phase observation based on the pseudorange observation for the second positioning epoch, the carrier phase observation for the second positioning epoch, and the RTK correction data associated with the second GNSS constellation;
generating a differential carrier phase observation for the second positioning epoch based on the carrier phase observation for the second positioning epoch; and
generating a PVT observation of the mobile device for the second positioning epoch based on the corrected pseudorange observation, the corrected carrier phase observation, and the differential carrier phase observation for the second positioning epoch.

9. The positioning method of claim 8, further comprising generating the PVT observation of the mobile device for the second positioning epoch based on the corrected pseudorange observation, the corrected carrier phase observation, the differential carrier phase observation for the second positioning epoch, and a PVT observation of the mobile device for a positioning epoch preceding the second positioning epoch.

10. The positioning method of claim 8, further comprising obtaining the RTK correction data associated with the second GNSS constellation from one or more base stations.

11. A positioning apparatus for a mobile device, comprising:
a global navigation satellite system (GNSS) receiver;
a memory; and
one or more processors communicatively coupled with the GNSS receiver and the memory, wherein the one or more processors are configured to:
obtain a pseudorange observation for a positioning epoch and a carrier phase observation for the positioning epoch based on measurements of GNSS signals transmitted by one or more space vehicles (SVs) of a GNSS constellation;
generate a differential carrier phase observation for the positioning epoch based on the carrier phase observation for the positioning epoch and a determination that real-time kinematic (RTK) correction data associated with the GNSS constellation is unavailable; and
generate a position, velocity, and time (PVT) observation of the mobile device for the positioning epoch based on the differential carrier phase observation for the positioning epoch.

12. The positioning apparatus of claim 11, wherein the one or more processors are further configured to generate the PVT observation of the mobile device for the positioning epoch based on the differential carrier phase observation for the positioning epoch and a PVT observation of the mobile device for a preceding positioning epoch.

13. The positioning apparatus of claim 11, wherein the one or more processors are further configured to discard the pseudorange observation for the positioning epoch in response to the determination that the RTK correction data associated with the GNSS constellation is unavailable and a determination that a residual error associated with the pseudorange observation for the positioning epoch exceeds a threshold.

14. The positioning apparatus of claim 11, wherein the one or more processors are further configured to generate the PVT observation of the mobile device for the positioning epoch according to an extended Kalman filter (EKF)-based positioning model.

15. The positioning apparatus of claim 14, wherein an estimation state of the EKF-based positioning model includes a current epoch position term and a previous epoch position term.

16. The positioning apparatus of claim 14, wherein an estimation state of the EKF-based positioning model includes a current epoch clock term and a previous epoch clock term.

17. The positioning apparatus of claim 14, wherein generating the PVT observation of the mobile device for the positioning epoch according to the EKF-based positioning model includes conducting a differential carrier phase measurement update based on a selection of a reference SV, wherein the differential carrier phase measurement update does not include updating a clock term.

18. The positioning apparatus of claim 11, wherein the one or more processors are further configured to:
obtain a pseudorange observation for a second positioning epoch and a carrier phase observation for the second positioning epoch based on measurements of GNSS signals transmitted by one or more SVs of a second GNSS constellation;
determine that RTK correction data associated with the second GNSS constellation is available;
generate a corrected pseudorange observation and a corrected carrier phase observation based on the pseudorange observation for the second positioning epoch, the carrier phase observation for the second positioning epoch, and the RTK correction data associated with the second GNSS constellation;
generate a differential carrier phase observation for the second positioning epoch based on the carrier phase observation for the second positioning epoch; and
generate a PVT observation of the mobile device for the second positioning epoch based on the corrected pseudorange observation, the corrected carrier phase observation, and the differential carrier phase observation for the second positioning epoch.

19. The positioning apparatus of claim 18, wherein the one or more processors are further configured to generate the PVT observation of the mobile device for the second positioning epoch based on the corrected pseudorange observation, the corrected carrier phase observation, the differential carrier phase observation for the second positioning epoch, and a PVT observation of the mobile device for a positioning epoch preceding the second positioning epoch.

20. The positioning apparatus of claim 18, wherein the one or more processors are further configured to obtain the RTK correction data associated with the second GNSS constellation from one or more base stations.

21. A non-transitory computer-readable medium storing instructions for positioning for a mobile device, the instructions comprising code for:
obtaining a pseudorange observation for a positioning epoch and a carrier phase observation for the positioning epoch based on measurements of global navigation satellite system (GNSS) signals transmitted by one or more space vehicles (SVs) of a GNSS constellation;
generating a differential carrier phase observation for the positioning epoch based on the carrier phase observation for the positioning epoch and a determination that real-time kinematic (RTK) correction data associated with the GNSS constellation is unavailable; and
generating a position, velocity, and time (PVT) observation of the mobile device for the positioning epoch based on the differential carrier phase observation for the positioning epoch.

22. The non-transitory computer-readable medium of claim 21, the instructions further comprising code for generating the PVT observation of the mobile device for the positioning epoch based on the differential carrier phase observation for the positioning epoch and a PVT observation of the mobile device for a preceding positioning epoch.

23. The non-transitory computer-readable medium of claim 21, the instructions further comprising code for discarding the pseudorange observation for the positioning epoch in response to the determining that the RTK correction data associated with the GNSS constellation is unavailable and a determination that a residual error associated with the pseudorange observation for the positioning epoch exceeds a threshold.

24. The non-transitory computer-readable medium of claim 21, the instructions further comprising code for generating the PVT observation of the mobile device for the positioning epoch according to an extended Kalman filter (EKF)-based positioning model.

25. The non-transitory computer-readable medium of claim 24, wherein an estimation state of the EKF-based positioning model includes a current epoch position term and a previous epoch position term.

26. The non-transitory computer-readable medium of claim 24, wherein an estimation state of the EKF-based positioning model includes a current epoch clock term and a previous epoch clock term.

27. The non-transitory computer-readable medium of claim 21, the instructions further comprising code for:
obtaining a pseudorange observation for a second positioning epoch and a carrier phase observation for the second positioning epoch based on measurements of GNSS signals transmitted by one or more SVs of a second GNSS constellation;
determining that RTK correction data associated with the second GNSS constellation is available;
generating a corrected pseudorange observation and a corrected carrier phase observation based on the pseudorange observation for the second positioning epoch, the carrier phase observation for the second positioning epoch, and the RTK correction data associated with the second GNSS constellation;
generating a differential carrier phase observation for the second positioning epoch based on the carrier phase observation for the second positioning epoch; and
generating a PVT observation of the mobile device for the second positioning epoch based on the corrected pseudorange observation, the corrected carrier phase observation, and the differential carrier phase observation for the second positioning epoch.

28. A positioning apparatus for a mobile device, comprising:
means for obtaining a pseudorange observation for a positioning epoch and a carrier phase observation for the positioning epoch based on measurements of global navigation satellite system (GNSS) signals transmitted by one or more space vehicles (SVs) of a GNSS constellation;
means for generating a differential carrier phase observation for the positioning epoch based on the carrier phase observation for the positioning epoch and a determination that real-time kinematic (RTK) correction data associated with the GNSS constellation is unavailable; and
means for generating a position, velocity, and time (PVT) observation of the mobile device for the positioning epoch based on the differential carrier phase observation for the positioning epoch.

29. The positioning apparatus of claim 28, further comprising means for generating the PVT observation of the mobile device for the positioning epoch based on the differential carrier phase observation for the positioning epoch and a PVT observation of the mobile device for a preceding positioning epoch.

30. The positioning apparatus of claim 28, further comprising means for discarding the pseudorange observation for the positioning epoch in response to the determining that the RTK correction data associated with the GNSS constellation is unavailable and a determination that a residual error associated with the pseudorange observation for the positioning epoch exceeds a threshold.
